(19) United States
(12) Patent Application Publication
(10) Pub. No.: US 2006/0264202 A1
(43) Pub. Date: Nov. 23, 2006

(54) System and method for authenticating clients in a client-server environment

(76) Inventors: Joachim Hagmeier, Stuttgart (DE); Joachim Bruchlos, Calw (DE); Timo Kussmaul, Boeblingen (DE)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 10/564,177

(22) PCT Filed: May 19, 2004
(86) PCT No.: PCT/EP04/50864

§ 371 Date: May 15, 2006

(30) Foreign Application Priority Data
Jul. 11, 2003 (EP) 03102111.6

(51) Int. Cl. H04M 1/66; H04M 1/68; H04M 3/16

(52) U.S. Cl. 455/411

(57) ABSTRACT

The idea of the present invention is to replace the existing password/user ID based authentication process by a new digital signature authentication process in which preferably the first HTTP-request header is extended by the client authentication information independently of the authentication process used by the destination server and without server requesting authentication information. The authentication information preferably includes the client certificate containing the client public key, signed by certification authority, and preferably a hash value calculated over the HTTP-request header data being sent in the request, and encrypted with the Client's private key. The certificate and digital signature may be added during the creation of the HTTP-request header in the client system itself, or may be added later in a server acting as a gateway, proxy, or tunnel. A destination server that does not support the new digital signature authentication process will simply ignore the certificate and digital signature in the HTTP-request header and will automatically initiate its own authentication process. The present invention simplifies the existing digital signature authentication process and concurrently allows the coexistence of different authentication processes without changing the HTTP-protocol or causing unnecessary network traffic.

### FIELD OF THE PRESENT INVENTION

The present invention relates to authentication in general, and in particular to authentication in a client-server environment, and more specifically to authentication of clients in the Internet.

### BACKGROUND OF THE INVENTION

Authentication is a procedure of determining whether someone or something is, in fact, who or what it is declared to be. In private and public computer networks authentication is commonly done by the use of logon passwords. Typically, every server maintains its own data persistency in order to store authentication data. Therefore, passwords which are available to the client on one server, may be already blocked by another client on another server. This increases the number of different authentication sets which have to be remembered and maintained by the client. In applications that are distributed over several servers with different user authentication systems (e.g. accessing an application through a portal server where the portal server uses its own user database) the client would have to logon more than once.

Workarounds to allow single signon contain approaches like storing logon data for the application servers on the portal server or the use of centralized user databases like Microsoft's®.NET Passport (http://www.passport.com) or Liberty from the Liberty Alliance (http://www.projectliberty.org). This requires that the client is willing to have personal data stored on a third party site with all the data security issues that come along with this approach. Also if the Passport service should be down one cannot logon to the desired service even if the site one wants to use is available.

Using a user ID/password set for authentication also has the disadvantage that it results in extra network traffic. On a client request the server has to answer by asking for the login data. Only after this is provided, the originally requested information is sent back to the client (see also FIG. 7A below).

Finally, passwords can often be stolen, accidentally revealed, or simply forgotten.

For this reason, Internet business and many other transactions require a more stringent authentication process. The use of digital certificates issued and verified by a Certificate Authority (CA) as part of a public key infrastructure is considered to become the standard way to perform authentication on the Internet.

Digital signatures enable the recipient (server) to verify the identity of the sender (client) and the origin as well as the integrity of the document.

Digital signatures are based on asymmetric cryptographic algorithms. The documents are signed with the private key of the sender. The recipient can take the sender's public key, which is provided to him by a Trusted Third Party, and validate the integrity of the document received.

The implementation of a digital signature procedure into an already existing password logon infrastructure requires great modifications on the server side as well as the client side, e.g. additional card reader with specific security applications. Therefore, such implementations cause much effort on costs and time with the consequences that preferably only new client-server infrastructures will be using the digital signature procedure. The existence of those two authentication procedures in the client-server environment has the disadvantage that a client has to check at first whether the destination server is supporting the password logon or the digital signature procedure. Depending on that result the client will use the required authentication process supported by the server. It causes much unnecessary network traffic between client and server since the server application itself finally determines the type of authentication. Furthermore, the present digital signature authentication procedures have the disadvantage that several screens between client and server have to be exchanged between client and server until the client can provide its authentication information. This causes much unnecessary network traffic.

### OBJECT OF THE INVENTION

Starting from this, the object of the present invention is to provide a method and system for authenticating clients in a client-server environment by avoiding the disadvantages of the above-mentioned prior art.

### BRIEF SUMMARY OF THE INVENTION

The idea of the present invention is to replace the existing password/user ID based authentication process by a new digital signature authentication process in which preferably the first HTTP-request header is extended by the client authentication information independently of the authentication process used by the destination server and without server requesting authentication information. The authentication information preferably includes the client certificate containing the client public key, signed by certification authority, and preferably a hash value calculated over the HTTP-request header data being sent in the request, and encrypted with the Client's private key. The certificate and digital signature may be added during the creation of the HTTP-request header in the client system itself, or may be added later in a server acting as a gateway, proxy, or tunnel.

A destination server that does not support the new digital signature authentication process will simply ignore the certificate and digital signature in the HTTP-request header and will automatically initiate its own authentication process. The present invention simplifies the existing digital signature authentication process and concurrently allows the coexistence of different authentication processes without changing the HTTP-protocol or causing unnecessary network traffic.

### BRIEF DESCRIPTION OF THE SEVERAL VIEWS OF THE DRAWINGS

The above, as well as additional objectives, features and advantages of the present invention will be apparent in the following detailed written description.

The novel features of the invention are set forth in the appended claims. The invention itself, however, as well as a preferred mode of use, further objectives, and advantages thereof, will be best understood by reference to the following detailed description of an illustrative embodiment when read in conjunction with the accompanying drawings, wherein:

FIG. 1A/B show prior art HTTP-client-server environments in which the present invention is preferably used,

FIG. 2 shows the basic structure of a typical prior art HTTP-header,

FIG. 3 shows the inventive structure of the HTTP-header with the certificate and the digital signature,

FIG. 4A-D show preferred embodiments to insert the certificate together with the digital signature into the HTTP-request header resulting in the inventive structure of the HTTP-request header,

FIG. 5 shows an example of a server-client communication environment using the present invention,

FIG. 6 shows a preferred embodiment of the authentication data flow in an client-server environment according to FIG. 1A using the inventive structure of the HTTP-request, and

FIG. 7A, B show a comparison of the prior art authentication process with the inventive authentication process of the present invention based on an example of a online purchase transaction process.

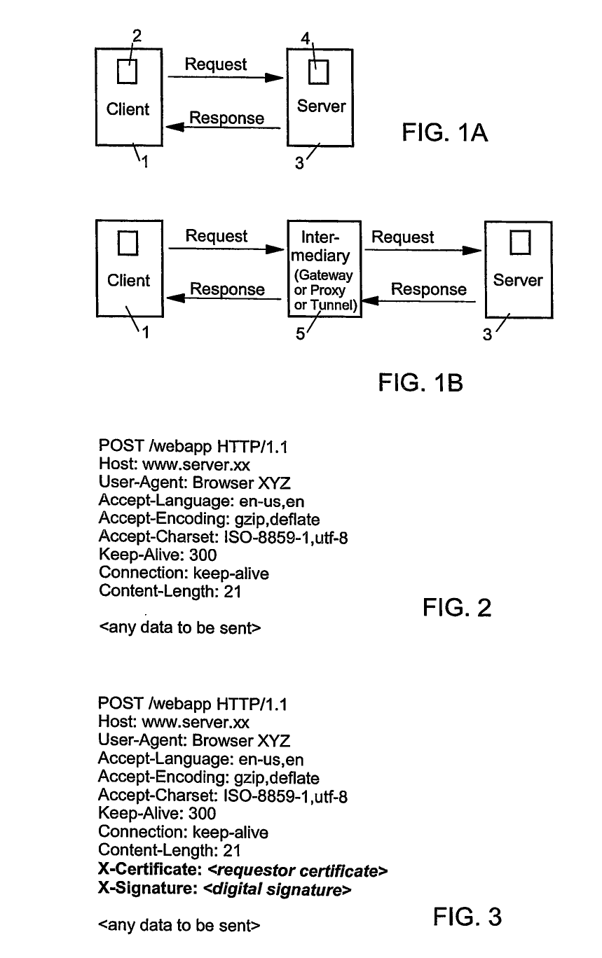

With reference to FIG. 1A and FIG. 1B, there are depicted client-server environments in which the present invention is preferably used. However it should be noted that the present invention may be used on each client-server environment using communication protocols allowing header extensions without violating normal protocol usage. Therefore, the present invention with its preferred embodiments will be described and explained on the currently mostly known HTTP-protocol.

The HTTP-protocol (Hypertext Transfer Protocol) is an application level protocol for distributed systems. It is a set of rules for exchanging files (text, graphic, images, sound, video, and other multimedia files). Any web server machine 3 contains a HTTP-daemon or so called HTTP-server 4, a program that is designed to wait for HTTP-requests and handle them when arrive. Furthermore, each client machine 1 contains a web browser or so-called HTTP-client 2, sending requests to web server machine 3. When the browser user enters a request by either opening a web file (typing in a URL) or clicking on a hypertext link, the browser builds an HTTP-request and sends it to the Internet Protocol Address indicated in the URL. The HTTP-server 4 in the destination server machine 3 receives the request and, after processing, the requested file is returned. In another client-server environment client 1 is communicating with the server 3 via a gateway, a tunnel, or a proxy-server 5 (see FIG. 1B).

Usually HTTP takes place over TCP/IP (Transmission Control Protocol/Internet Protocol), however HTTP is not dependent on TCP/IP.

TCP defines a set of rules to exchange messages with other Internet points at the information package level, and IP defines a set of rules to send and receive messages at the Internet address level.

An HTTP-request header consists of the HTTP method (GET, HEAD, POST, etc.), the Universal Resource Identifier (URI), the protocol version and optional supplemental information.

An HTTP-response consists of a status line, which indicates success or failure of the request, a description of the information in the response (meta information) and the actual information request.

With respect to FIG. 2, there is depicted the basis structure of a prior art HTTP-request header. Each HTTP-request must contain at least a header. Only HTTP-Post requests contain header and body data. Following information are preferably contained in a HTTP-request header:

Resources to be accessed by the HTTP-request (e.g. file, servlet)

The host name of the server (e.g. www.ibm.com) Browser name and version (e.g. Netscape Version 7.1) Operating system of the client (e.g. Windows XP) Character set that can be understood by the browser (e.g. iso-8859-1).

Each HTTP-header may include supplemental information not defined by the HTTP-protocol and which does not conflict with existing applications using the HTTP-protocol. That means that an application which uses the HTTP-protocol and which is not configured to process that supplemental information simply ignores that supplemental information without interrupting its execution.

With respect to FIG. 3, there is depicted the inventive structure of a HTTP-request header according to the present invention.

Following additional information according to the present invention must be included into the HTTP-request header:

the client certificate containing the public key and signed by a certification authority, and

digital signature calculated over the HTTP-request header and if available HTTP-body (Post).

The certificate and digital signature can be processed by specific tools on the server. A client certificate is a document distributed by a Trusted Third Party that binds a public key to a specific person. The Trusted Party guarantees that the information contained in the certificate is valid and correct. Certificates are standardized by 509. They should contain the digital signature of the Trusted Third party, the name of the person owning the public key, and the public key itself.

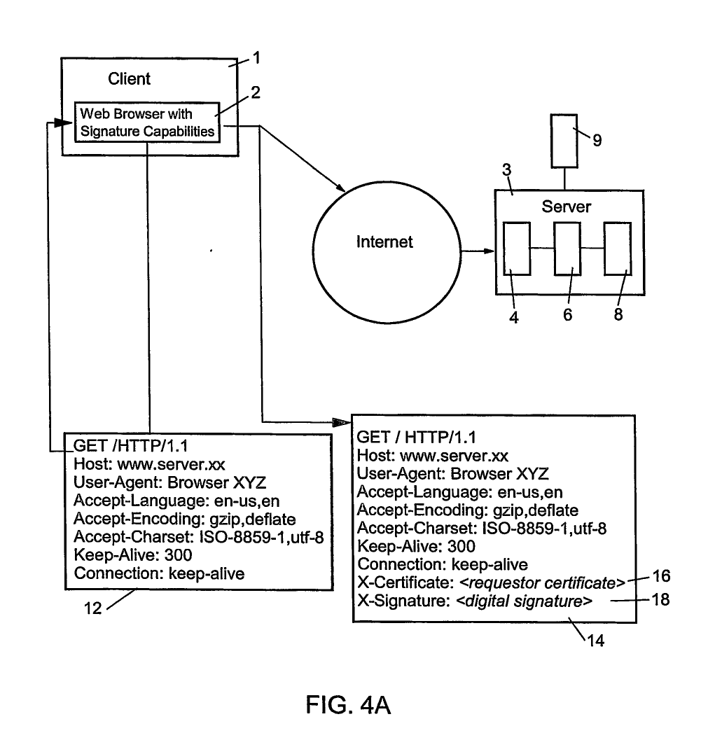

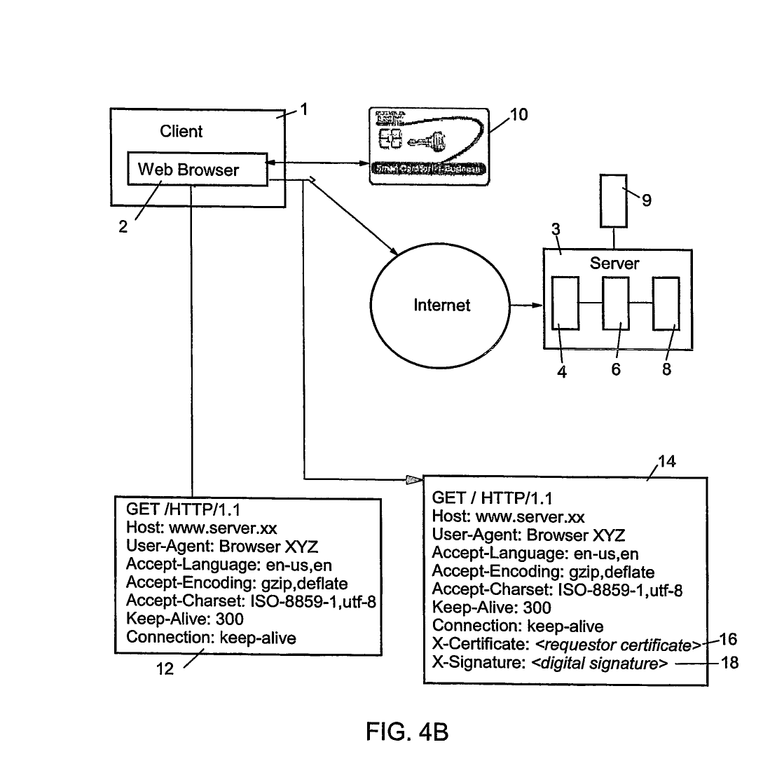

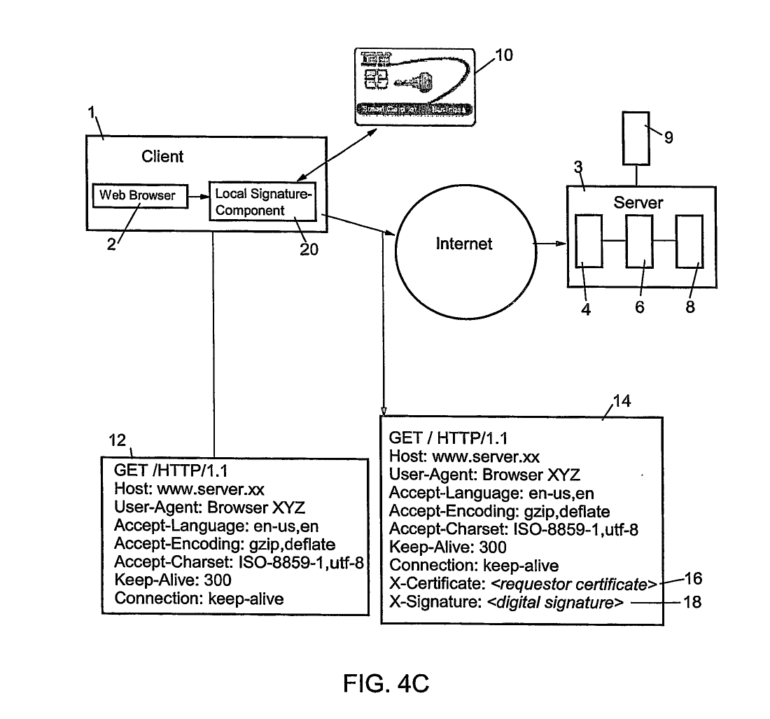

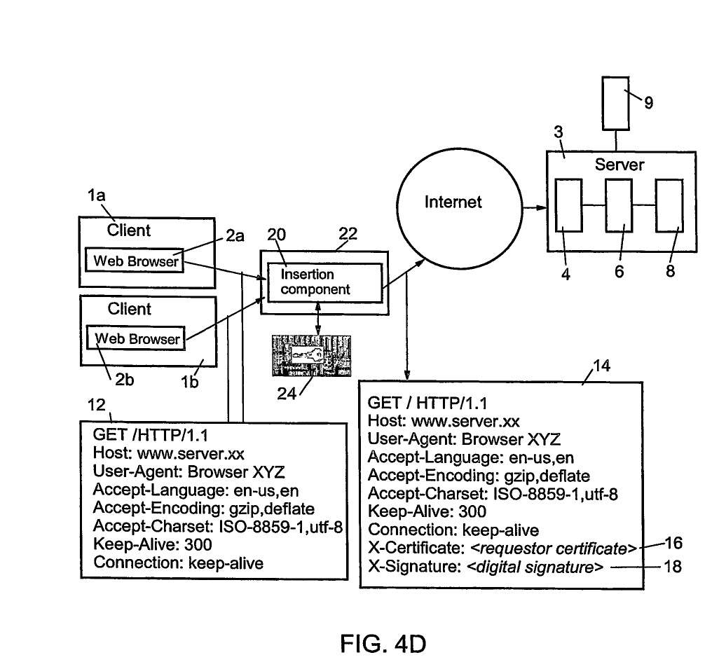

With respect to FIG. 4A-C, there are depicted preferred embodiments to insert the client certificate and the digital signature into the HTTP-request header,

With respect to FIG. 4A, there is depicted a first embodiment of the present invention to insert Client's certificate 16 together with the digital signature 18 into the HTTP-request header 12. The client system 1 contains a browser 2 with signature capabilities. The browser 2 generates a HTTP-request header 12, accesses the client's private key which is securely stored on a local file system, encrypts a hash value generated over the HTTP-request header 12 and if available body, with the private key resulting in a digital signature 18. That digital signature 18 together with the Client certificate 16 containing the public key is inserted in the HTTP-request header 12. The extended HTTP-request header 14 is sent to the HTTP-server 4 that initiates the authentication process. The authentication component 6 which may be part of the HTTP-server or may be a separate component verifies the client certificate information 16 from the HTTP-request header. Verification can either be done by checking the certificate signature of Certification Authority or comparing it with already known certificates contained in its certification database 9. Using the public key contained in the client certificate 16, the digital signature 18 contained in the HTT-request header 12 is decrypted resulting in a hash value calculated by the client 1. Using the same hash algorithm, the hash value is calculated over the HTTP-request header 12 and body if available. If hash values match verification is completed and the authentication is successful and access to an application 8 is given.

With respect to FIG. 4 B, there is depicted a second embodiment of the present invention to insert Client certificate 18 together with the digital signature 16 into the HTTP-request header 12. Now the browser 2 has the functionality to communicate with a smart card 10 via a smart card reader 10. The browser 2 generates a HTTP-request header, establishes communication with the smart card 10, the smart card 10 which contains in its security module a private key and Client's certificate encrypts a hash value generated over the HTTP-header 12 and if available body, with the private key (digital signature), and returns a digital signature 18 together with client's certificate 16 to the browser 2. That digital signature 18 together with Client's certificate 16 containing the public key is inserted in the HTTP-request header 12. The extended HTTP-request header 14 is sent to the HTTP-server 4 that initiates the authentication process by using an authentication component (see description to FIG. 4A)

With respect to FIG. 4C, there is depicted a third embodiment of the present invention to insert Client's certificate 16 together with the digital signature 18 into the HTTP-request header 12. In the third embodiment the client system contains an own signature component 20. That component acts as a proxy server running on the same client 1 as the browser 2. The browser 2 is configured to use that proxy server 20. Because of this the browser 2 sends the regularly HTTP-request header 12 to the signature component 20 which then inserts the certificate 16 and digital signature 18 analog to the embodiments as described above. The extended HTTP-request header is sent to the HTTP-server 4 that initiates the authentication process by using an authentication component (see description to FIG. 4A).

With respect to FIG. 4 D, there is depicted a fourth embodiment of the present invention to insert Client certificate 18 together with the digital signature 16 into the HTTP-request header 12. In that embodiment the client-request (1a/2a; 1b/2b) is routed via a proxy server 22 having an insertion component 20. The insertion component 20 is communicating with an encryption hardware 24 containing private keys and their assigned certificates, which encrypts a hash value generated over the HTTP-request header 12 and if available body, with the private key (digital signature), and returns digital signature 18 with the client certificate 16 to the insertion component 20 inserting them into the HTTP-request header 12. The extended HTTP-request header 14 is sent to the HTTP-server 4 that initiates the authentication process by using an authentication component (see description to FIG. 4A).

Anyway, because the present invention describes additional header data in the HTTP protocol, all combinations of existing clients and servers that are able to process the additional data in the header can work together. If one of the systems is not enabled to handle additional data everything will work as known today.

To keep the existing base of billions of installed client browsers, an additional signature software could handle the HTTP extension by acting as a proxy component on the local client machine (see FIG. 4C). Within company networks (e.g. intranet), this could even be handled by a central proxy server (FIG. 4C).

Future versions of Web Browsers then may have the functionality build in (FIG. 4A). This way the transition to the new paradigm can happen over time.

The digital signature can be created using a signature smart card or any other signature hardware. Also a pure software solution with an encrypted key store on the client computer would be a possible implementation.

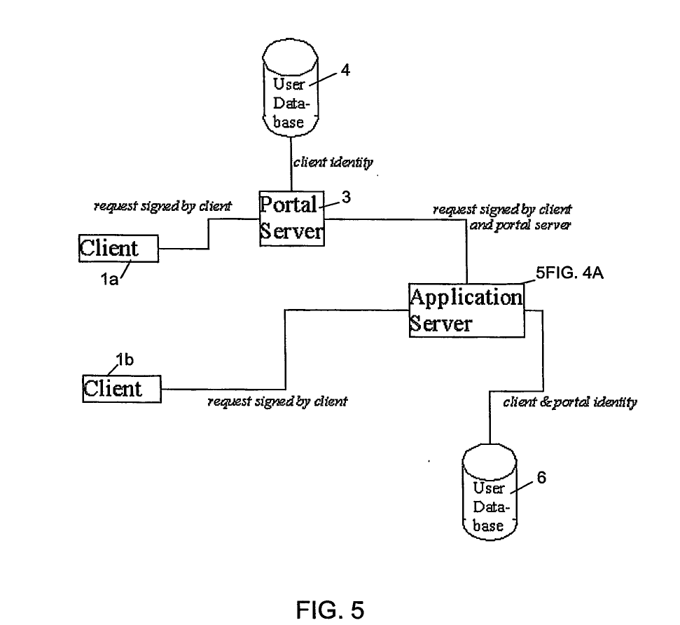

FIG. 5 shows an example of a server-client communication environment using the present invention.

In this example it is assumed that an application 5 is accessed through a portal server 3. In the state of art this situation is handled by either storing the client's identity data on a server that is accessible by the portal server 3 and the application server 5 (e.g. Microsoft's®.NET Passport) or the identity data for the application server needs to be stored on the portal server 3. Both approaches require the user to have his/her data stored on a third party system which is subject to many security issues.

By digitally signing the request as explained in FIG. 4A-D, no server needs to store the user data. The portal server 3 can check the identity of the requester against its user database 4, passing the request along to the application server 5 which can do the same using its user database 6. Client 1a accesses the application server 5 through the portal server 3 while Client 1b can access the application server 5 directly. The application server 5 can use its own user database 6 to retrieve profile information for the user.

The approach even provides higher security since the application server 5 might want to handle only those requests that passed the portal server 3. In this case the portal server 3 forwards the request and additionally signs it. This enables the application server 5 to verify both signatures in order to either grant or deny access to its services. Client la would gain access to the application server 5 while Client lb would not be served because its request does not go through the portal server 3.

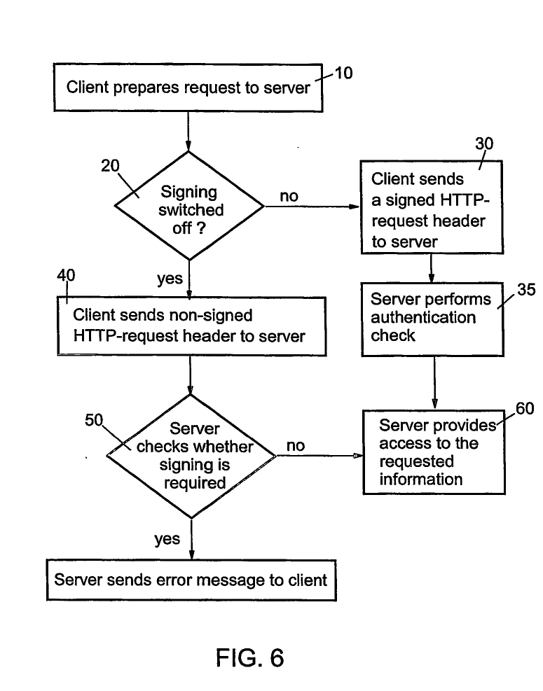

With respect to FIG. 6, there is depicted the authentication a data flow according to the present invention. Client's browser prepares request to the server 10. In a preferred embodiment of the present invention it will be checked whether signing of the HTTP-request header is switched on 20. If not, Client's browser will send a non-signed request to the server 40 and the server checks whether signing is required 50. If signing is required server will send an error message to the client 50. If signing is not required the server will provide access to the desired information 60.

If signing is switched on the client's browser inserts certificate and digital signature into the HTTP-request header, and sends that HTTP-request header to the server 30. By appending the extra fields to the HTTP header request header the server is able to retrieve the requester's identity from the certificate (authentication) 35. The Client's certificate contains the requester's name and public key.

Because it is signed by a trusted authority, the server is able to verify that it is a valid certificate issued by the trusted authority. Verification that the message has been really sent by the owner of the certificate is possible, because only the owner of the private key belonging to the certificate can have generated the digital signature value in the HTTP-request header which has been calculated over the HTTP-request header data and can be verified through the use of the public key contained in the certificate. If the authentication has been successful, the server provides access to the requested data 60.

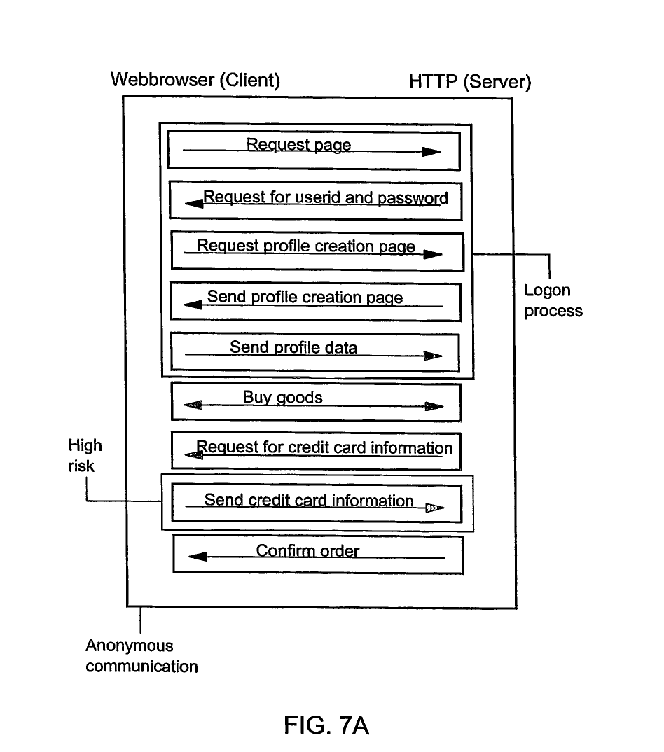

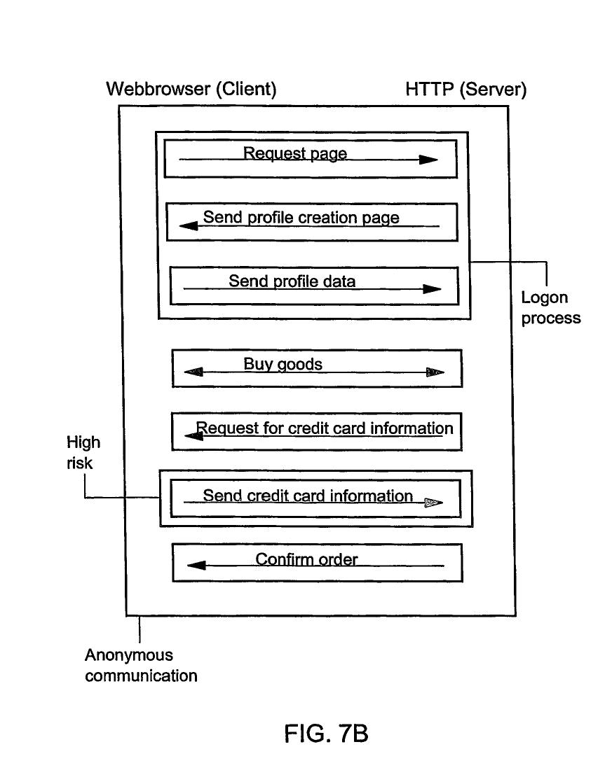

With respect to FIG. 7A, B, there are depicted typical scenarios of the exchange of information between Web browser (client) and Web server (server) using the prior art authentication process in comparison with the inventive authentication process of the present invention.

For example, during a purchase process, the client receives and sends data (e.g. a series of text or html pages or blocks of formatted data like XML) from and to the server representing the online shopping system until the order gets confirmed by a specific data transfer operation (e.g. HTTP Post). In today's applications, the server issues a request to obtain a user Id and password from the client during this process. The user has to supply these data manually before they are sent to the server by the client application (see FIG. 7A).

In an application corresponding to the present invention (see FIG. 7B), the client signs the HTTP-request header data being sent to the server by means of a digital signature. The server easily identifies the client by checking the signature. It's therefore not necessary to request and supply the user Id and password, since every data item transmitted is associated with the user's identity. The server may retrieve stored information for this client and use this information in preparing the data which is to be sent to the client (“personalization”, profile creation page). Examples for data used for personalization are the user's address (where should the ordered items be delivered to), the users shopping history, the users shopping cart, the web pages visited during the last sessions etc.

By checking the identity of the user (which can be done at any time during the flow), the server may find out that the user never visited this site before. The server may then send data containing a request to specify preferences and detailed user data (profile creation page). The user supplies these data, the client application sends it to the server and the server stores these data used for personalization in its data base. Since every data transfer is signed, the user ID of the client is known to the server as soon as the client visits the first page. The personalization may therefore take place early during the process.

When the user chooses to switch off signing, the server recognizes this fact and may send a page containing an indication to switch on signing or might use traditional user ID/password scenarios instead (not shown).

1. Method for authenticating clients in a client-server environment, wherein said client-server environment uses a communication protocol that allows extensions of the header request without violating said communication protocol, wherein said client comprises the steps of:
generating a header request(10),
inserting client authentication information into said header request resulting in an extended header request (20) independently of the authentication process used by said server and without server requesting authentication information,
sending said extended header request to a server (30),
and receiving information from said server if authentication has been successful (35,60).

2. Method according to claim 1, wherein said communication protocol is a HTTP-protocol.

3. Method according to claim 1, wherein said authentication information is included in the first header request for establishing a session with said server.

4. Method according to claim 1, wherein said authentication information comprises the client certificate containing client's name and client public key, and a digital signature which has been generated over a hash value of the header request including client certificate using Client private key.

5. Method according to claim 1, wherein said authentication information is automatically inserted into said header request by the Client's browser.

6. Method according to claim 5, wherein said client browser receives said authentication information from a smart card (10) via a smart card reader.

7. Method according to claim 1, wherein said authentication information is automatically inserted into said header request by a client signature component (20) which receives said authentication information from a smart card (10) via a smart card reader.

8. Method for authenticating clients (1a, 1b) in a client-server environment, wherein said client-server environment uses a communication protocol that allows extensions of the header request without violating said communication protocol, wherein a system (22) establishes communication between said client (1a, 1b) and said server (3), wherein said system(22) comprises the steps of:
receiving a header request from said client (1a, 1b),
inserting authentication information into said header request resulting in an extended header request(20) independently of the authentication process used by said server and without server requesting authentication information,
sending said extended header request to a server (3), and
receiving information from said server (3), if the authentication has been successful.

9. Method according to claim 8, wherein said system (20) can be a proxy server, a gateway, or a tunnel.

10. Method according to claim 8, wherein said communication protocol is the HTTP-protocol, and said authentication information is automatically inserted into said HTTP-request header by said an insertion component (20) which receives said authentication information from a signature component (24).

11. Method according to claim 8, wherein said authentication information comprises the client certificate containing client's name and client's public key, and a digital signature which has been generated over the whole header request including client certificate using Client's private key.

12. Method for authenticating clients in a client-server environment, wherein said client-server environment uses a communication protocol that allows extensions of the header request without violating said communication protocol, wherein at said server side said method comprises the steps of:
receiving a client header request containing authentication information,
validating said authentication information contained in said header request by said server authentication component, and
providing information to said client, if the authentication has been successful.

13. Method according to claim 12, wherein said authentication information comprises the client certificate containing client's name and client's public key, and a digital signature which has been generated over the whole header request content using Client's private key.

14. Method according to claim 12, wherein said communication protocol is the HTTP-protocol, and said authentication component performs the steps of:
accessing said public key contained in the client certificate, decrypting said digital signature contained in the HTTP-request header with said public key resulting in a hash value, applying the same hash algorithm as used by said client to said HTTP-request header, and
considering authentication as successful, if both hash values match.

15. Server System (3) for authenticating clients (1) in a client-service environment, wherein said client-server environment uses a communication protocol that allows extensions of the header request without violating said communication protocol, wherein said client (1) provides authentication information in the header request to said server system, wherein said server system (3) comprising:
an authentication component (4) with the functionality to read said authentication information contained in the incoming client header request, and to validate said authentication information without having requested said authentication information from said client.

16. Client System (1) to be authenticated by a server system in client-server environment, wherein said client-server environment uses a communication protocol that allows extensions of the header request without violating said communication protocol, wherein said client system comprising:
a browser (2), and
a component for inserting client authentication information into said header request independently of the authentication process used by said server and without server requesting authentication information.

17. Client System according to claim 16, wherein said authentication information comprises the client certificate containing client's name and client's public key, and a digital signature which has been generated over the hash value of the header request content using Client's private key.

18. Client System according to claim 16, further comprising
a smart card reader (10), and
a smart card (10) with a security module containing client's private key and a client certificate containing client name and private key, wherein said smart card provides said certificate together with a digital signature to said inserting component, wherein said digital signature is the result of an encryption of a hash value of said header request containing said certificate information by means of said private key.

19. Proxy Server system (22) for providing client authentication information to a server system (3), wherein said proxy server system (22) has a communication connection with a client system (1a, 1b) and a server system (3), wherein said communication protocol used between said systems allows extensions of the header request of said header request without violating said communication protocol, wherein said proxy server system (22) comprising:
a proxy insertion component (20) for inserting the client certificate and digital signature into the header request received from said client independently of the authentication process used by said server and without server requesting authentication information, and
a signature component (24) for creating a digital signature and for providing it together with said client certificate to said proxy insertion component (20).

20. Computer program product stored in the internal memory of a digital computer, containing parts of software code to execute the method in accordance with claim 1-14 if the product is run on the computer.
